(19) United States
(12) Patent Application Publication
(10) Pub. No.: US 2014/0074628 A1
(43) Pub. Date: Mar. 13, 2014

(54) SYSTEM FOR PERSONALLY CURATING AN OFFER LIST

(71) Applicants: Mark Hunter Madsen, Vancouver (CA); William Nicholas Weir, Phoenixville, PA (US)

(72) Inventors: Mark Hunter Madsen, Vancouver (CA); William Nicholas Weir, Phoenixville, PA (US)

(73) Assignee: ChoozOn Corporation, King of Prussia, PA (US)

(21) Appl. No.: 13/612,652

(22) Filed: Sep. 12, 2012

(51) Int. Cl. G06Q 30/02

(52) U.S. Cl. CPC G06Q 30/0277
USPC 705/14.73

(57) ABSTRACT

An improved system and method for personally curating an offer list of promotional offers from multiple offer sources in an online service is provided. Components for personally curated offer lists support operations accessible through a graphical use interface for creating, editing, sharing, and updating personally curated offer lists, as well as curating and viewing offers of the offer lists. A user may author and manage a personal list of promotional offers curated from multiple offer sources, such as brands, product types, places, deal clubs, shopping pals, and offer lists. The personally curated offer list may be shared with others such as shopping pals who may have similar interests. New offers may be added to the personally curated offer list, and the present invention may further notify others with whom the list is shared of such updates to the offer list.

### CROSS-REFERENCE TO RELATED APPLICATIONS

The present invention is related to the following United States patent application, filed concurrently herewith and incorporated herein in its entirety:

“Method for Personally Curating an Offer List,” Attorney Docket No. 0020.

### FIELD OF THE INVENTION

The invention relates generally to computer systems, and more particularly to an improved system and method for personally curating an offer list of promotional offers from multiple offer sources provided by an online service.

### BACKGROUND OF THE INVENTION

In the emerging web-based deal economy today, merchants representing thousands of different products work with affiliate networks of online publishers that post their offers across hundreds or thousands of locations on the Web. These merchants operate an infrastructure or engage specialized networks such as Commission Junction, LinkShare, or the Google Affiliate Network that provide services which carefully track actions by online users on online publisher websites, such as impressions viewed, click-throughs and purchases, and typically compensate by commissions the publishers who drive leads and sales.

A number of online publisher websites have become aggregators of deals and coupons, such as Coupon Mountain and Coupon Cabin. These online publishers focus on aggregating the largest number of offers from the largest number of brands possible, and some have built coupon directories representing thousands of coupons. To increase the number of deals published on their websites, some aggregators such as RetailMeNot and SlickDeals invite the public to post deals on their websites that were found elsewhere. Although such websites attract a large online audience, consumers are easily overwhelmed by the number of deals on these websites and often suffer a tedious and daunting user experience from searching through the giant inventory in these website directories to find relevant deals and coupons. As a result, many consumers experience deal fatigue from browsing such websites and abandon their search without finding relevant deals or coupons.

On the other end of the spectrum, some online publisher websites feature one or relatively few daily deals. In particular, group discount buying was introduced by Living Social, popularized by Groupon, and quickly emulated by hundreds of such websites offering deals in every major American city. Such websites send one deal per day that is price-discounted by 50% to 80% if group buying minimums are met. Whereas online publisher websites of giant coupon directories may overwhelm consumers with excessive choices, deal-of-the-day websites may feature a rather narrow range of high-margin, low-cost services from local businesses that may not always be relevant to a consumer. Moreover, consumers are now becoming overwhelmed by the recent proliferation of local daily deals and group discount offers.

Whether browsing on coupon warehouse websites, daily deal websites or group discount offer websites, consumers find it too difficult to discover deals online and become frustrated by surfing multiple sites in search of relevant deals. What is needed is a system and method for an online user to quickly and easily find relevant offers at the right time. Such a system and method should allow users to retrieve and then save offers of interest, regardless of where the users may find them.

### SUMMARY OF THE INVENTION

Briefly, the present invention may provide a system and method for personally curating an offer list of promotional offers from multiple offer sources provided by an online service. In various embodiments, a client computer or mobile computing device may be operably connected to an offer server. The client computer or mobile computing device may include an offer application operably coupled to an offer application user interface having functionality for visualization and navigation of a graphical user interface for requesting and displaying information about personally curated offer lists, and more particularly, for receiving input from a user interacting through the graphical user interface to request performance of an operation for a personally curated offer list and functionality for displaying results received from the server after performing the requested operation for the personally curated offer list.

The offer application user interface may be operably coupled to a curated offer list user interface and a personalized curated offer list user interface. The curated offer list user interface provides components with functionality for a user interacting with user interface elements of a graphical user interface to create, edit, share, and update personally curated offer lists, as well as curate and view offers of a personally curated offer list. The personalized curated offer list user interface provides components with functionality for a user interacting with user interface elements of a graphical user interface to navigate among a list of the user's personally curated offer lists and display promotional offers from the user's personally curated offer lists.

In response to receiving a request to perform an operation for a personally curated offer list, an offer server, having support services for providing promotional offers and personally curated offer lists, may process requests to perform operations on a personally curated offer list. In an embodiment, the offer server may include a consumer offer application with functionality to generate a curated offer list of promotional offers from multiple offer sources. The consumer offer application may include a brand component that manages brand information for brands, a product type component that manages product type information for product types, an offer component that manages offer information for offers, an offer list component that manages offer list information for offer lists, and a consumer application programming interface (API) that may be invoked to perform operations provided by the consumer application component. The consumer API may include an offer list API that may be invoked to perform operations on a personally curated offer list.

Moreover, the present invention may provide operations for managing a personally curated offer list of promotional offers from multiple offer sources provided by an online service. Such operations include creating a personally curated offer list, editing a personally curated offer list, sharing a personally curated offer list, and updating a personally curated offer list. An offer list personally curated by a user of an online service may be generated and shared by the user of the online service with other users of the online service. The personally curated offer list may be updated by its curator, for instance by adding one or more additional offers, and others users with whom the list is shared may be notified of such updates to the personally curated offer list.

Advantageously, the present invention may flexibly allow personally curating a list of offers from multiple offer sources, such as brand lists, product type lists, place lists, deal club lists, shopping pal lists, offer lists, and so forth. The user interface provided for personally curating offer lists may include navigation controls for creating personally curated offer lists, for managing visibility, and for sharing and browsing of personally curated offer lists. Moreover, the user interface may support various presentations and representations of a personally curated offer list in a graphical user interface such as a stack of offers, a pile of offers, a folder of offers, an album of offers, a board of offers, a wall of offers and other organizational depictions of a personally curated list of offers.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for personally curating an offer list of promotional offers from multiple offer sources provided by an online service, in accordance with an aspect of the present invention;

FIG. 3 is a block diagram generally representing an exemplary architecture of system components of the offer application user interface, in accordance with an aspect of the present invention;

FIG. 4 is a flowchart generally representing the steps undertaken in an embodiment for personally curating an offer list of promotional offers that are shared with other users, in accordance with an aspect of the present invention;

FIG. 5 is a flowchart generally representing the steps undertaken in an embodiment for generating a personally curated offer list of promotional offers selected from multiple offer sources by a curator, in accordance with an aspect of the present invention;

FIG. 6 is a flowchart generally representing the steps undertaken in an embodiment for selecting one or more promotional offers from multiple offer sources for a personally curated offer list, in accordance with an aspect of the present invention;

FIG. 7 is a flowchart generally representing the steps undertaken in an embodiment for selecting an offer source for a personally curated offer list, in accordance with an aspect of the present invention;

FIG. 8 is an exemplary illustration generally representing a screen of a graphical user interface for displaying information about offer lists in an online service, in accordance with an aspect of the present invention;

FIG. 9 is a flowchart generally representing the steps undertaken in an embodiment for saving an offer in a personally curated offer list, in accordance with an aspect of the present invention;

FIG. 10 is an exemplary illustration generally representing a screen of a graphical user interface for saving an offer in an online service and, more particularly, for saving an offer in a personally curated offer list, in accordance with an aspect of the present invention;

FIG. 11 is a flowchart generally representing the steps undertaken in an embodiment for saving an offer in an existing personally curated offer list, in accordance with an aspect of the present invention;

FIG. 12 is a flowchart generally representing the steps undertaken in an embodiment for saving an offer in a new list of personally curated offers, in accordance with an aspect of the present invention;

FIG. 13 is an exemplary illustration generally representing a screen of a graphical user interface for creating a new list in which personally curated offers may be saved, in accordance with an aspect of the present invention;

FIG. 14 is a flowchart generally representing the steps undertaken in an embodiment for assigning attributes to an offer list of personally curated offers, in accordance with an aspect of the present invention;

FIG. 15 is a flowchart generally representing the steps undertaken in an embodiment with a graphical user interface for creating an offer list personally curated from multiple offer sources, in accordance with an aspect of the present invention;

FIG. 16 is a flowchart generally representing the steps undertaken in an embodiment for sharing a personally curated offer list, in accordance with an aspect of the present invention;

FIG. 17 is a flowchart generally representing the steps undertaken in an embodiment with a graphical user interface for sharing a personally curated offer list, in accordance with an aspect of the present invention;

FIG. 18 is an exemplary illustration generally representing a screen of a graphical user interface for sharing an offer list in an online service and, more particularly, for sharing a board of personally curated offers in an embodiment of a graphical user interface presenting a list of offers as a board of offers, in accordance with an aspect of the present invention;

FIG. 19 is an exemplary illustration generally representing a screen of a graphical user interface for setting attributes to share a personally curated offer list in an online service and, more particularly, for setting attributes to share a board of personally curated offers in an embodiment of a graphical user interface presenting a list of offers as a board of offers, in accordance with an aspect of the present invention;

FIG. 20 is a flowchart generally representing the steps undertaken in one embodiment for updating a personally curated offer list with an offer, in accordance with an aspect of the present invention;

FIG. 21 is a flowchart generally representing the steps undertaken in one embodiment with a graphical user interface for updating a personally curated offer list with an offer, in accordance with an aspect of the present invention; and

FIG. 22 is a flowchart generally representing the steps undertaken in one embodiment for notifying others, with whom the personally curated offer list is shared, of updates to the personally curated offer list, in accordance with an aspect of the present invention.

### DETAILED DESCRIPTION

### Exemplary Operating Environment

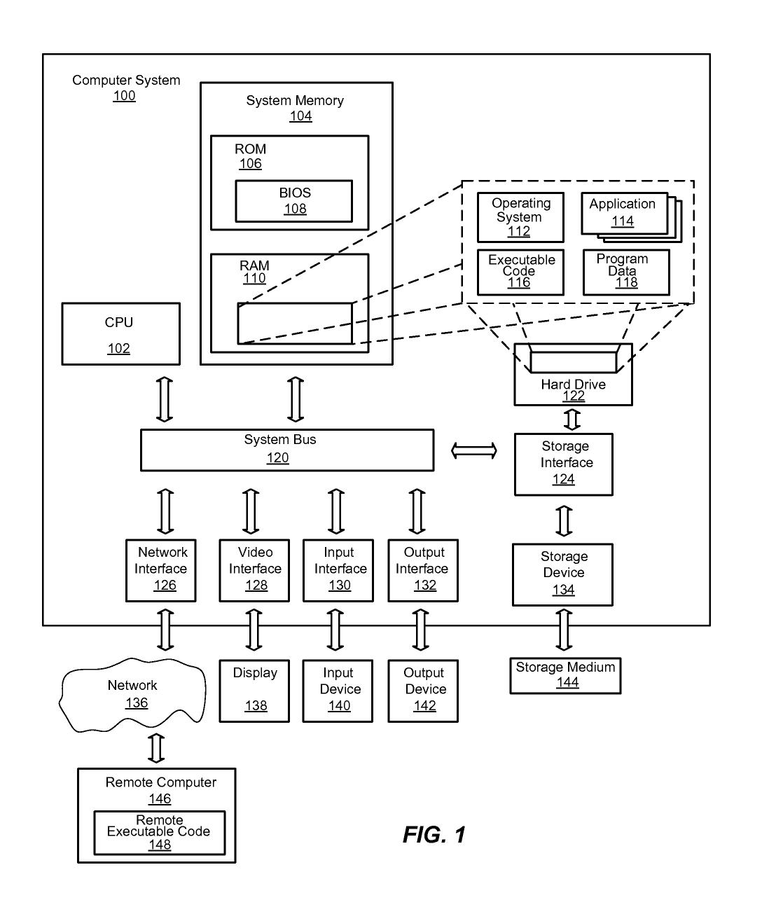

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be a solid-state drive that reads from or writes to non-removable, nonvolatile solid-state storage. Alternatively, storage device 134 may be a solid-state drive, an optical disk drive or a magnetic disk drive that reads from or writes to a removable, a nonvolatile storage medium 144 such as solid-state storage, an optical disk or magnetic disk. Other removable/non-removable, volatile/nonvolatile computer storage media that can be used in the exemplary computer system 100 include, but are not limited to, magnetic tape cassettes, flash memory cards, flash drives, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Those skilled in the art will appreciate that the computer system 100 may also be implemented within a system-on-a-chip architecture including memory, external interfaces and an operating system.

### Personally Curating an Offer List

The present invention is generally directed towards a system and method for personally curating an offer list of promotional offers from multiple offer sources provided by an online service. More particularly, the present invention allows a user to author and manage a personal list of promotional offers curated from multiple offer sources, such as brand lists, product type lists, place lists, deal club lists, shopping pal lists, offer lists, etc. The personally curated offer list may be shared with others such as shopping pals. New offers may be added to the personally curated offer list, and the present invention may further notify others with whom the list is shared of such updates to the offer list.

As used herein, an offer or promotional offer means any online promotion for goods or services, including without limitation coupons, vouchers, advertisements, and so forth. An offer list is a list of multiple offers, and, in an embodiment, may also include one or more offer lists. As will be seen, there may be various presentations and representations of a personally curated offer list in a graphical user interface such as a stack of offers, a pile of offers, a folder of offers, an album of offers, and other organizational depictions of a personally curated list of offers. Moreover, as will be understood, the various block diagrams, flow charts, and illustrations described herein are only examples, and there are many other scenarios to which the present invention will apply.

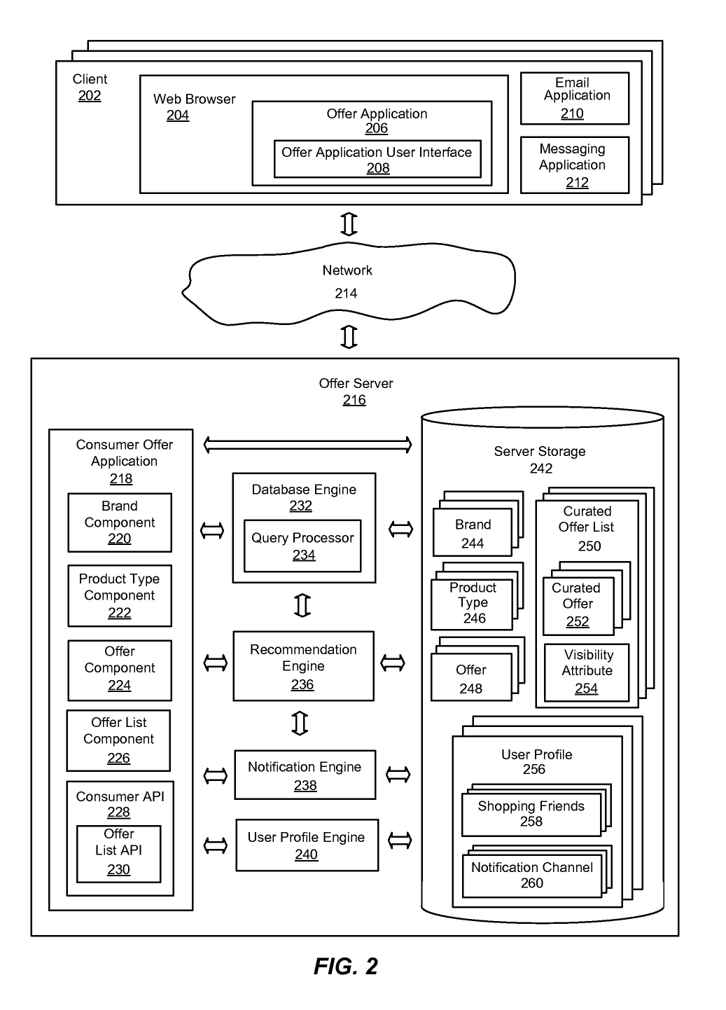

Turning to FIG. 2 of the drawings, there is shown a block diagram generally representing an exemplary architecture of system components for personally curating an offer list of promotional offers from multiple offer sources provided by an online service. Those skilled in the art will appreciate that the functionality implemented within the blocks illustrated in the diagram may be implemented as separate components or the functionality of several or all of the blocks may be implemented within a single component. For example, the functionality for the offer application 206 on the client 202 may be implemented as a separate component from the web browser 204, which may be the case for a mobile device such as a smartphone. Note that in an embodiment on a mobile device, the functionality of the offer application 206 may be implemented both within the web browser 204 as shown and as a separate component so that a mobile device user may use either the web browser 204 with the functionality of the offer application 206 included or the offer application 206 as a separate application component. Moreover, those skilled in the art will appreciate that the functionality implemented within the blocks illustrated in the diagram may be executed on a single computer or distributed across a plurality of computers for execution. Furthermore, those skilled in the art may also appreciate that the functionality of the present invention may also be implemented using a thin client whereby the functionality of the web browser 204, the offer application 206, the email application 210, and the messaging application 212 may be implemented on the offer server 216. In such an embodiment, the client 202 merely acts as an interface for a user to interact with the offer server 216.

In various embodiments, a client 202 may communicate with one or more offer servers 216 through a network 214. The client 202 may be a computer such as computer system 100 of FIG. 1 or another computing device including a mobile device such as a mobile phone. The network 214 may be any type of network such as a local area network (LAN), a wide area network (WAN), or other type of network. A web browser 204 may execute on the client 202 and may include functionality for receiving a request to perform an operation which may be input by a user and functionality for sending the request to a server to perform the operation. The web browser 204 may be operably coupled to an offer application 206 having functionality for receiving requests to perform an operation for a personally curated offer list and functionality for sending the requests to the offer server 216 to perform the requested operation for the personally curated offer list. For instance, those skilled in the art will appreciate that the offer application may execute on a client 202 as a browser toolbar or as an application of a browser toolbar in an embodiment. In any of these embodiments, the offer application 206 may be operably coupled to an offer application user interface 208 having functionality for visualization and navigation of a graphical user interface for requesting and displaying information about personally curated offer lists, and more particularly, for receiving input from a user interacting through the graphical user interface to request performance of an operation for a personally curated offer list and functionality for displaying results received from the offer server 216 after performing the requested operation for the personally curated offer list.

Other applications may also execute on the client 202 in various embodiments. For example, in embodiments where the client 202 may be a computing device such as a mobile phone, an offer application 206 operably coupled with an offer application user interface 208 may execute on the mobile phone. The offer application 206 in this embodiment may have functionality for receiving requests to perform an operation for a personally curated offer list and functionality for sending the requests to the offer server 216 to perform the requested operation for the personally curated offer list. The offer application user interface 208 in this embodiment may have functionality for visualization and navigation of a graphical user interface for requesting and displaying information about personally curated offer lists, and more particularly, for receiving input from a user interacting through the graphical user interface to request performance of an operation for a personally curated offer list and functionality for displaying results received from the offer server 216 after performing the requested operation for the personally curated offer list.

Moreover, additional applications may execute on the client 202 that enable notification of updates of a personally curated offer list in various embodiments through multiple notification channels to subscribers with whom the personally curated offer list is shared. For instance, an email application 210 may function both as an instant or periodic notification channel to receive updates about a personally curated offer list that is shared and may also function as a communication channel for a user to request performance of an operation for a personally curated offer list. Those skilled in the art may recognize that email messages may function as commands to the offer server 216 to perform any functions supported by the server 216. Finally, the messaging application 212 may also serve as an occasional or periodic notification channel to receive updates about a personally curated offer list that is shared and may also function as a communication channel for a user to request performance of an operation for a personally curated offer list. The messaging application 212 may be any type of messaging application including an instant messaging application, a text messaging application such as Simple Message Service (SMS), a chat messaging application, and so forth.

In general, the web browser 204, the offer application 206, the offer application user interface 208, the email application 210, and the messaging application 212 may be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The offer server 216 may be any type of computer system or computing device such as computer system 100 of FIG. 1. In general, the server 216 may support services for providing promotional offers and offer lists, functionality for processing requests to perform an operation for a personally curated offer list, and functionality for sending the requests to the offer server 216 to perform the requested operation for the personally curated offer list. In particular, the server 216 may include a consumer offer application 218 which includes functionality to provide personally curated offer lists of promotional offers from multiple offer sources. The consumer offer application 218 may include a brand component 220 that manages brand information for brands, a product type component 222 that manages product type information for product types, an offer component 224 that manages offer information for offers, an offer list component 226 that manages offer list information for offer lists, and a consumer application programming interface (API) 228 that may be invoked to perform operations provided by the consumer application component 218 including operations performed by the brand component 220 for brands, operations performed by the product type component 222 for product types, operations performed by the offer component 224 for offers, and operations performed by the offer list component 226 for offer lists. The consumer API 228 may include an offer list application programming interface (API) 230 that may be invoked to perform operations for offer lists, including operations performed by the offer list component 226 for personally curating an offer list of promotional offers from multiple sources.

The consumer offer application 218 may be operably coupled to a database engine 232, a recommendation engine 236, a notification engine 238 and a user profile engine 240. The database engine 232 may provide database services and may include a query processor 234 having functionality to process received queries by retrieving the data from the server storage 242 and processing the retrieved data. The recommendation engine 236 may also be operably coupled to the database engine 232 and the notification engine 238. The recommendation engine 236 may provide recommendation services for the various operations of the consumer offer application 218 and may have functionality for receiving requests for recommendations for an operation of the consumer offer application 218, retrieving and ranking results, and returning a list of recommendations for the requested operation of the consumer offer application 218. The notification engine 238 may have functionality for receiving updates to offers, offer lists, and other information for which a user may request notification, and the notification engine 238 may have functionality for sending notification of such updates in various embodiments through multiple notification channels including email application 210 and messaging application 212. The offer server 216 may additionally include a user profile engine 240 that manages user profile information including notification channels assigned to a user.

The consumer offer application 218, each of its components, the database engine 232, the recommendation engine 236, the notification engine 238 and user profile engine 240 may each be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system. Alternatively, these components may also be implemented on a general purpose computing system or device as interpreted or executable software code such as a kernel component, an application program, a script, a linked library, an object with methods, and so forth.

The offer server 216 may additionally include server storage 242. The consumer offer application 218, database engine 232, the recommendation engine 236, the notification engine 238, and the user profile engine 240 may be operably coupled to server storage 242 that stores information for brands 244, information for product types 246, information for offers 248, information for curated offer lists 250, and information for user profiles 256 including information of shopping friends 258 and information of notification channels 260. The information saved in the server storage 242 for curated offer lists 250 may further include information for curated offers 252 and a visibility attribute 254 that may, for instance, specify for which users of an online service information about the curated offer list may be displayed. The information stored in the server storage 242 may be stored in a database in an embodiment.

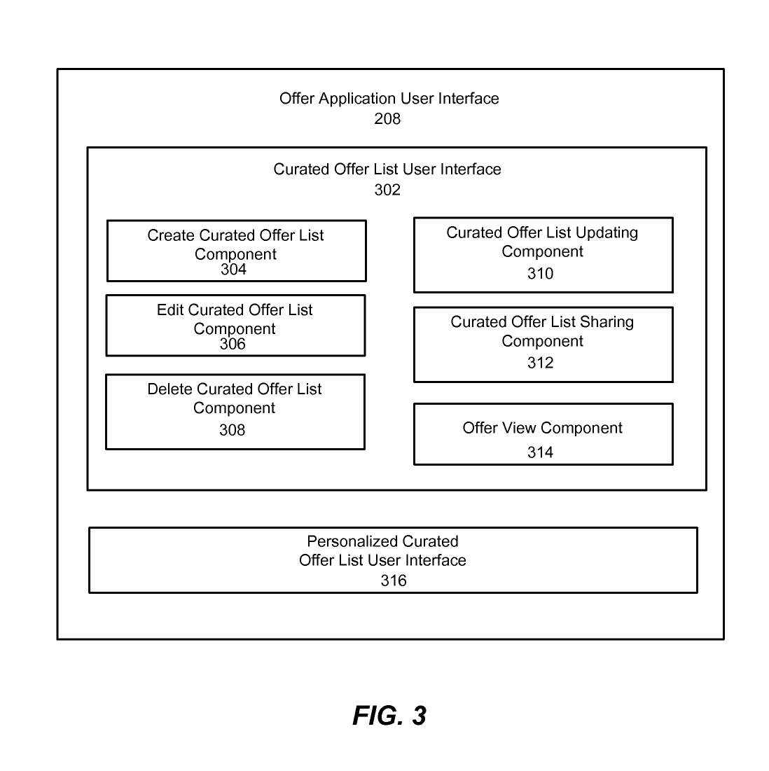

FIG. 3 presents a block diagram generally representing an exemplary architecture of system components of the offer application user interface 208. Those skilled in the art will appreciate that the functionality implemented within the blocks illustrated in the diagram may be implemented as separate components or the functionality of several or all of the blocks may be implemented within a single component. For example, the functionality of the curated offer list updating component 308 may be implemented as a separate component from the functionality of curated offer list sharing component 310 as shown. Or the functionality of the curated offer list updating component 308 may be included in the same component as the functionality of curated offer list sharing component 310. Moreover, those skilled in the art will appreciate that the functionality implemented within the blocks illustrated in the diagram may be executed on a single computer or distributed across a plurality of computers for execution.

In various embodiments, the offer application user interface 208 may be operably coupled to a curated offer list user interface 302 and a personalized curated offer list user interface 314. In general, the curated offer list user interface 302 provides functionality for a user interacting with user interface elements of a graphical user interface to create, edit, delete and share curated offer lists, as well as curate and view offers of curated offer lists. As used herein, an element in a graphical user interface means any graphical user interface object such as a window, including without limitation, an application window, a dialog box, a message box, a toolbar, a control, a button, a menu, and so forth. In addition to a graphical user interface object such as a window, an element may also include a pane or frame of a window. The personalized curated offer list user interface 316 provides functionality for a user interacting with user interface elements of a graphical user interface to navigate among a list of the user's personally curated offer lists and display promotional offers from the user's personally curated offer lists. The curated offer list user interface 302 may include a create curated offer list component 304 for creating a personally curated offer list, an edit curated offer list component 306 for editing attributes of a personally curated offer list, a delete curated offer list component 308 for deleting a personally curated offer list, a curated offer list updating component 310 for updating a personally curated offer list with personally curated offers, a curated offer list sharing component 312 for making visible and sharing a personally curated offer list, and offer view component 314 for generating the presentation of promotional offers displayed within a screen of a graphical user interface to view offers of a personally curated offer list.

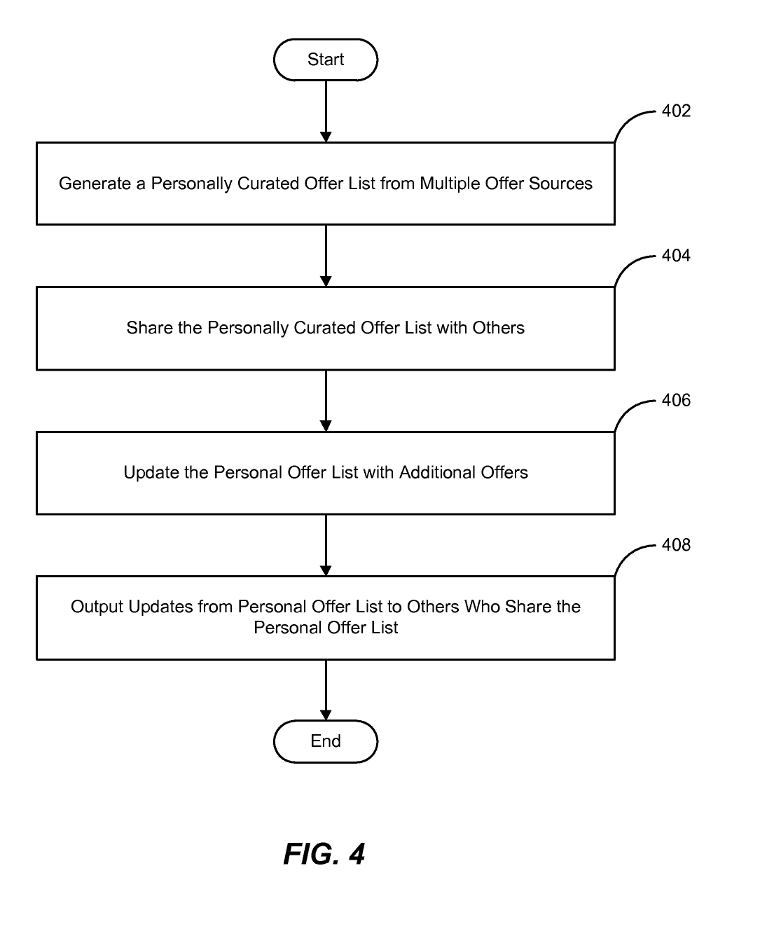

FIG. 4 presents a flowchart generally representing the steps undertaken in one embodiment for personally curating an offer list of promotional offers that are shared with other users. In general, a personally curated offer list may be generated at step 402. In an embodiment, a user may personally curate an offer list of promotional offers from multiple offer sources provided by an online service such as brand lists, product type lists, place lists, deal club lists, shopping pal lists, offer lists, etc. At step 404, the personally curated offer list may be shared by the curator with others. In an embodiment, a visibility attribute may be set by the curator to make visible and share the personally curated offer list with shopping pals or any users of an online offer service. The personally curated offer list may be updated with additional offers by the curator at step 406. For instance, the curator of the personally curated offer list may select additional promotional offers from multiple sources and save them to the personally curated offer list in an embodiment. And the updates of the additional offers by the curator may be output at step 408 to others with whom the personally curated offer list is shared. In various embodiments, the updates may be output through multiple notification channels to others with whom the personally curated offer list is shared. For instance, notification of updates to the personally curated offer list may be sent by email, instant messaging, or other occasional or periodic notification channels.

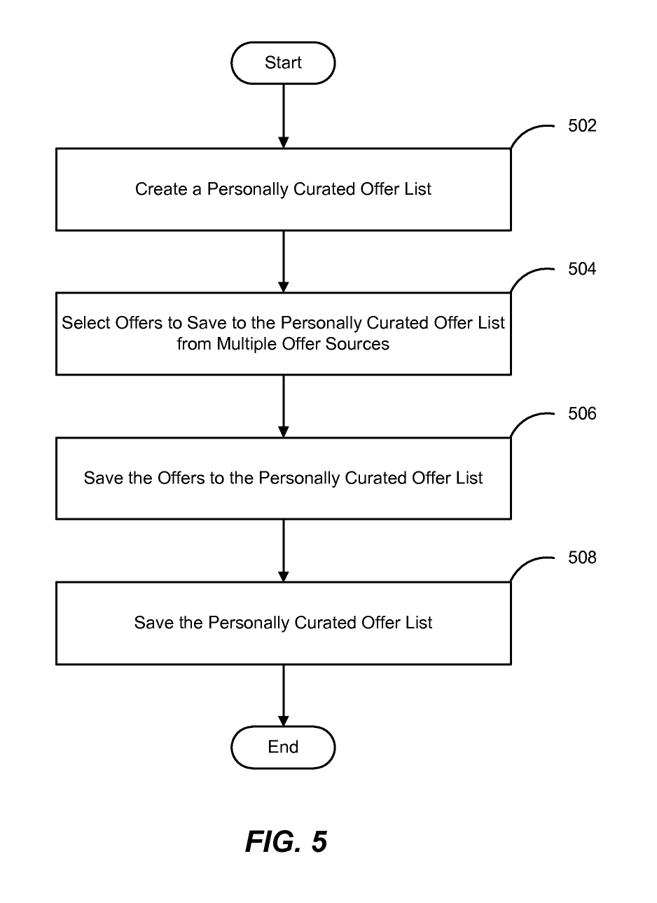

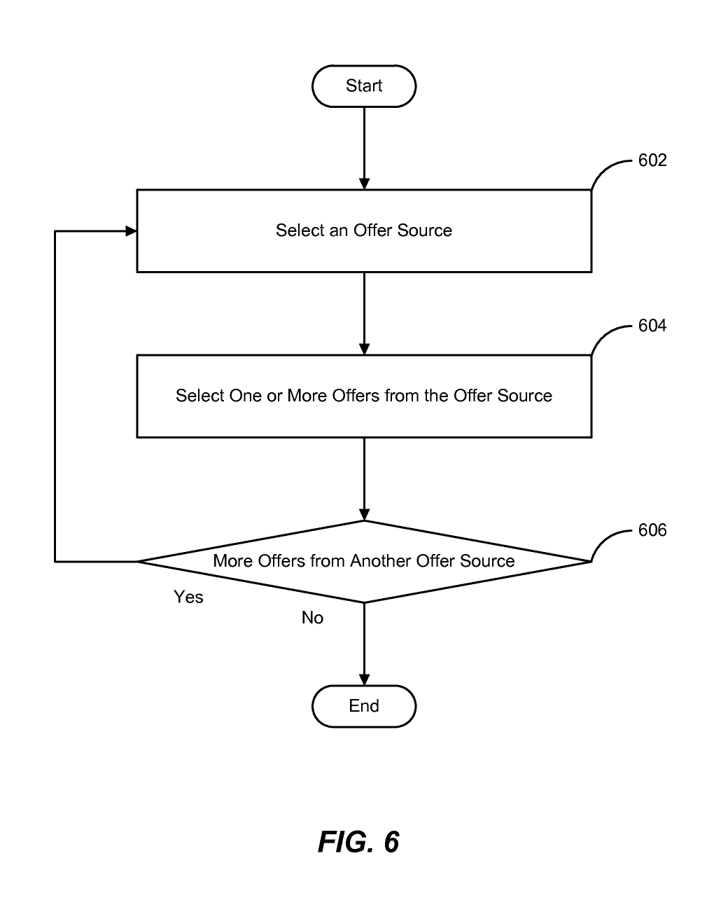

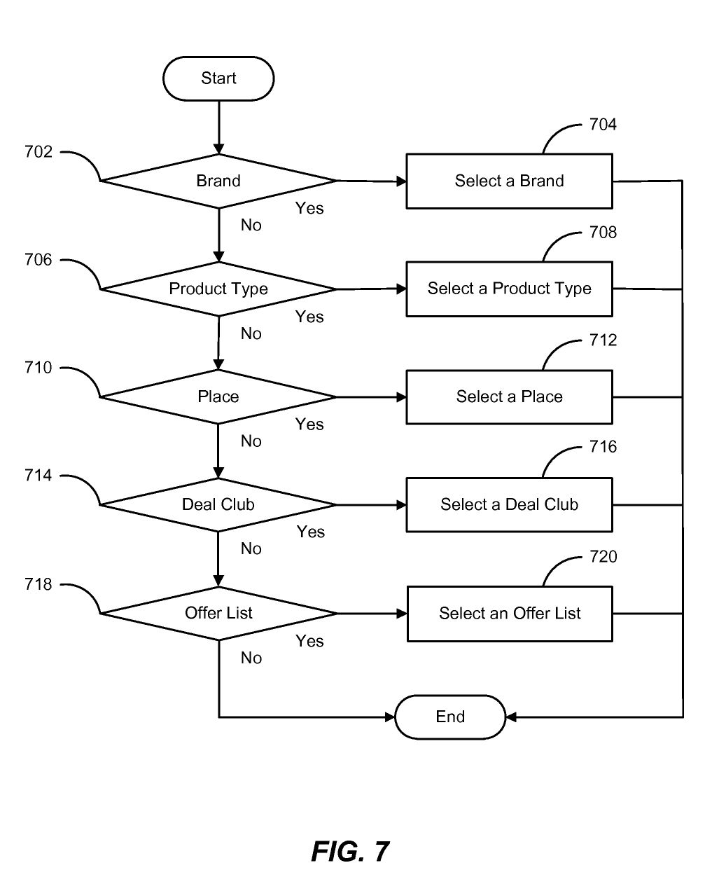

FIG. 5 presents a flowchart generally representing the steps undertaken in one embodiment for generating a personally curated offer list of promotional offers selected from multiple offer sources by a curator. At step 502, a personally curated offer list may be created. In an embodiment, a request may be made by a curator interacting with user interface elements of a graphical user interface to create an offer list of promotional offers. In various embodiments, the request may be sent by a client device to an offer server to create the offer list. At step 504, one or more promotional offers may be selected to be saved to the personally curated offer list from multiple offer sources. In an embodiment, the one or more promotional offers may be selected by a curator from multiple offer sources such as brands, product types, places, deal clubs, shopping pals, and offer lists, as described below in further detail in conjunction with FIGS. 6-7. At step 506, the promotional offers selected by the curator may be saved to the personally curated offer list, and the personally curated offer list may be saved at step 508 for instance in persistent storage such as server storage 242 of FIG. 2.

FIG. 6 presents a flowchart generally representing the steps undertaken in one embodiment for selecting one or more promotional offers from multiple offer sources for a personally curated offer list. At step 602, an offer source may be selected. And at step 604, one or more offers may be selected from the offer source. In various embodiments, a list of offers from an offer source may be selected for a personally curated offer list. For example, a list of offers for a brand or a product type may be selected, a list of offers for a deal club may be selected, an offer list such as a personally curated offer list may be selected, or a list from another offer source may be selected. It may then be decided whether there may be more offers to be select from another offer source at step 606. If so, then processing may continue at step 602 where an offer source may be selected. Otherwise, processing may be finished. As used herein, a product type means a grouping of goods or services, and a deal club means a group of users with shared access to an offer list curated by one or more of the group of users.

FIG. 7 presents a flowchart generally representing the steps undertaken in one embodiment for selecting an offer source for a personally curated offer list. At step 702, it may be determined whether an indication may be received that a brand may be selected as an offer source. For instance, an indication may be received that a user interface control was clicked upon for selecting a brand as an offer source in an embodiment. If an indication was received that a brand was selected as an offer source, then a brand may be selected as an offer source at step 704. Otherwise, it may be determined at step 706 whether an indication may be received that a product type may be selected as an offer source. If it may be determined that an indication was received that a product type was selected as an offer source, then a product type may be selected as an offer source at step 708. If it may be determined at step 706 that an indication was not received that a product type may be selected as an offer source, then it may be determined at step 710 whether an indication may be received that a place may be selected as an offer source.

If it may be determined that an indication was received that a place was selected as an offer source, then a place may be selected as an offer source at step 712. As used herein, a place means a location of an area of any scope, including for example a region, city, shopping mall, a department within a store, and so forth. In various embodiments, offers grouped by a place provide an offer source. If it may be determined at step 710 that an indication was not received that a place may be selected as an offer source, then it may be determined at step 714 whether an indication may be received that a deal club may be selected as an offer source.

If it may be determined that an indication was received that a deal club was selected as an offer source, then a deal club may be selected as an offer source at step 716. If it may be determined at step 714 that an indication was not received that a deal club may be selected as an offer source, then it may be determined at step 718 whether an indication may be received that an offer list may be selected as an offer source. If so, then an offer list may be selected as an offer source at step 720; otherwise, processing may be finished.

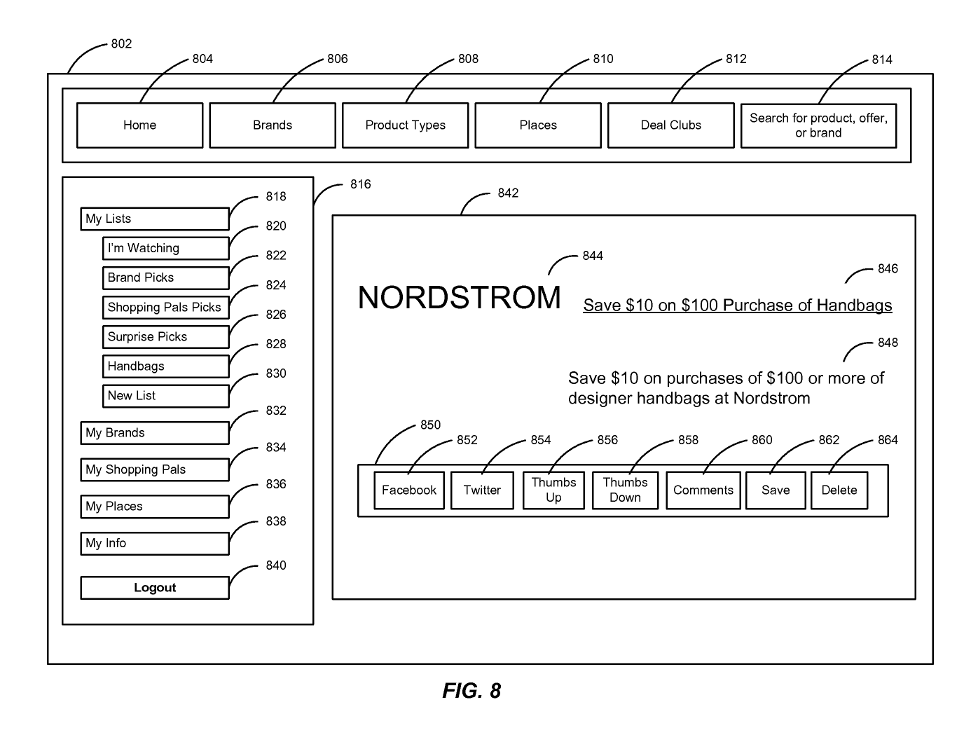

FIG. 8 presents an exemplary illustration generally representing a screen of a graphical user interface for displaying information about offer lists in an online service. The screen 802 in FIG. 8 shows the window of a graphical user interface for a web browser executing an offer application with a personally curated offer list illustrated under a dropdown menu 818 labeled “My List”. In an embodiment, the window of the graphical user interface for the web browser executing the offer application 802 may display user interface elements for a home page 804 and various offer sources such as a dropdown menu for brands 806, a dropdown menu for product types 808, a button for places 810, a button for deal clubs 812, an input text box 814 to enter a search string and so forth. Further illustrated within the window of the graphical user interface for the web browser executing the offer application 802 is a personalization pane 816 which may display user interface elements for navigating among various offer sources personalized by a user of the online service, such as a dropdown menu for My Lists 818, a dropdown menu for My Brands 832, a dropdown menu for My Shopping Pals 834, a dropdown menu for My Places 836, a dropdown menu for My Info 838, a button Logout 840 selectable to logout of the service, and so forth. User interface elements within the dropdown menu of My Lists 818 are illustrated for navigating among various personalized offer lists, including personally curated offer lists. For example, a button 820 labeled “I'm Watching” may be selected to display a list of offer selected by a user for monitoring, or a button 822 labeled “Brand Picks” may be selected to display a list of offer recommended to a user for brands chosen by a user. Further illustrated is a button 824 labeled “Shopping Pals Picks” that may be selected to display a list of offer chosen by a user's shopping pals, and a button 826 labeled “Surprise Picks” that may be selected to display a list of offer recommended for brands or product types not chosen by a user. Also illustrated is a button 828 labeled “Handbags” that may be selected to display a list of personally curated offers that the user named “Handbags”, and a button 830 labeled “New List” that may be selected to create a new list of personally curated offers.

Furthermore illustrated within the window of the graphical user interface for the web browser executing the offer application 802 is a content pane 842 which may display content such a list of promotional offers from the various offer sources, including personally curated offer lists. In particular, content pane 842 of FIG. 8 illustrates the display elements of an offer that may appear in an offer list and may include a representation of a brand such as a text string of a brand name like “NORDSTROM” 844, or alternatively an image representing a trade name, service name or trademark, a hyperlink 846 that includes headline text of the offer and an address of a uniform resource locator (URL) to redeem the offer, and a description 848 of the offer. The content pane 842 of FIG. 8 also illustrates the display of an offer action toolbar 850 with user interface elements for performing various actions such as providing comments, saving or deleting the offer. In an embodiment, the offer action toolbar 850 may include a button 852 labeled “Facebook” to comment (post) on the offer through Facebook, a button 854 labeled “Twitter” to comment (broadcast) on the offer through Twitter, a button 856 labeled “Thumbs Up” to provide an indication of approval of the offer by a user, a button 858 labeled “Thumbs Down” to provide an indication of disapproval of the offer by a user, a button 862 labeled “Save” to save an offer to an offer list such as a personally curated offer list, and a button 864 labeled “Delete” to delete an offer from an offer list such as a personally curated offer list. Those skilled in the art will appreciate that an image may be displayed on any button of the offer action toolbar 850 instead of a text label as shown in FIG. 8. In an embodiment, an offer such as the offer shown in content pane 842 of FIG. 8 may be saved by selecting the button 862 labeled “Save” in the offer action toolbar 850 to save the offer to a personally curated offer list such as the list of personally curated offers that the user named “Handbags” discussed above.

In general, a user of the online offer service may select the dropdown menu 818 labeled “My List” in various embodiments to navigate to a display of a list of personally curated offer lists that are visible to the user of the online offer service. For instance, when a user selects the dropdown menu 818 labeled “My List” in an embodiment, a list of personally curated offer lists that are visible to the user of the online offer service may be displayed. In such an embodiment, the consumer offer application 218 may verify for example that the user is a shopping pal of the curator of the personally curated offer list where the personally curated offer list is assigned a visibility to shopping pals.

In any of these embodiments, those skilled in the art will appreciate that the list of personally curated offer lists displayed to a user may be selected by the online offer service using various criteria for selection including based on visibility to the user, user preferences for product types, user preferences for brands and so forth.

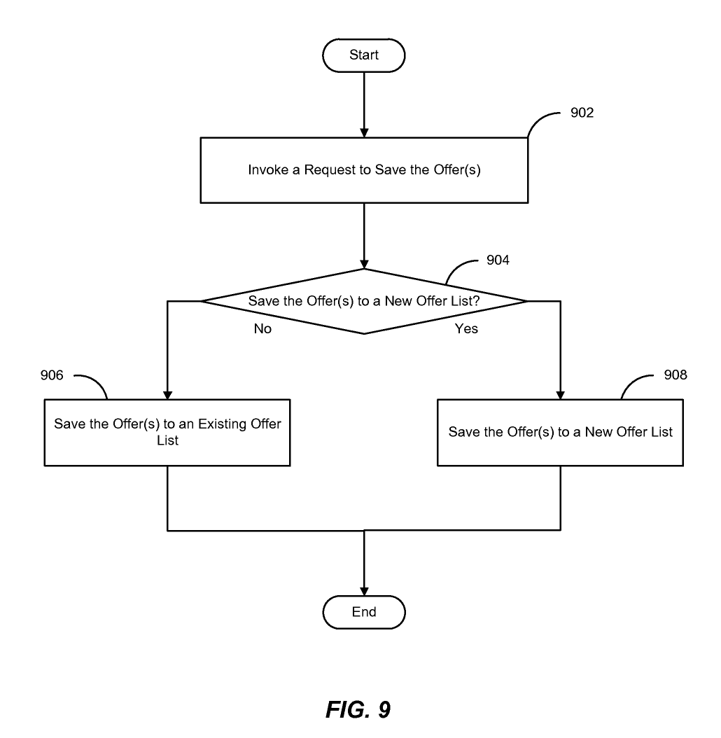

FIG. 9 presents a flowchart generally representing the steps undertaken in one embodiment for saving an offer in a personally curated offer list. At step 902, a request to save an offer may be invoked. For instance, a user may select the Save button in the offer action toolbar 850 described in conjunction with FIG. 8 to save the offer in an embodiment. In general, a user may save an offer to a personally curated offer list by adding the offer to an existing list or creating a new list and adding the offer to the new list. Accordingly, it may then be determined at step 904 whether the offer is to be saved in a new offer list. If it is determined to save the offer in a new offer list, then the offer may be saved to a new offer list at step 908. Otherwise, the offer may be saved to an existing offer list at step 906. For example, an offer such as the offer shown in content pane 842 of FIG. 8 may be saved to the list of personally curated offers that the user named “Handbags” discussed above.

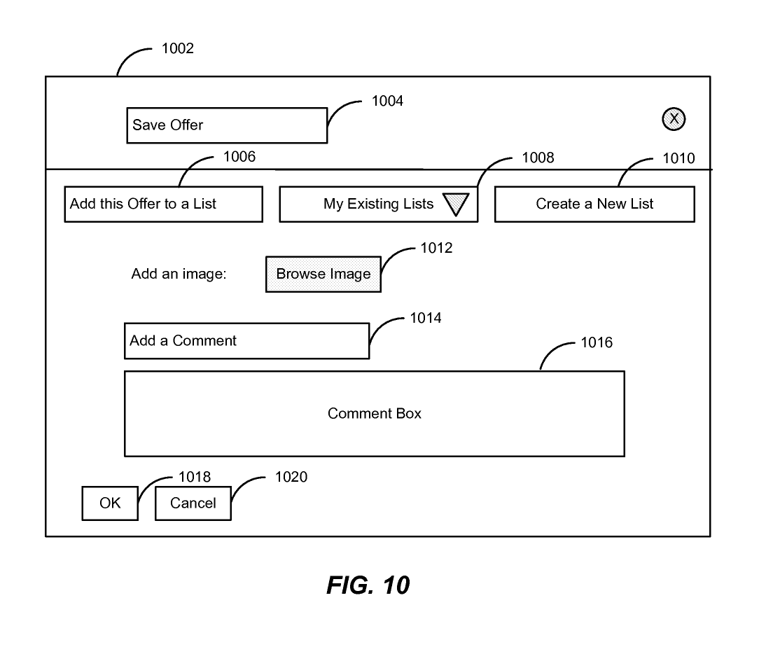

FIG. 10 presents an exemplary illustration generally representing a screen of a graphical user interface for saving an offer in an online service and, more particularly, for saving an offer in a personally curated offer list. The screen 1002 in FIG. 10 shows the window of a graphical user interface for saving an offer in a web browser executing an offer application. In an embodiment, the window of the graphical user interface for saving an offer in a web browser executing an offer application may display user interface elements such as an input button 1004 to save an offer, an input button 1006 to add the offer to a list, a dropdown menu 1008 labeled “My Existing Lists” to display personalized offer lists including personally curated offer lists, an input button 1010 labeled “Create a New List” to create a personally curated offer list in which the offer may be saved, an input button 1012 labeled “Browse Image” to find and select an address of the location of an image representing the offer list, an input button 1014 labeled “Add a Comment” which may be selected to add a comment about the offer that may be entered into text input box 1016 labeled “Comment Box”, an input button 1018 labeled “OK” that may be selected to perform the operations selected, and an input button 1020 labeled “Cancel” that may be selected to cancel the operations selected.

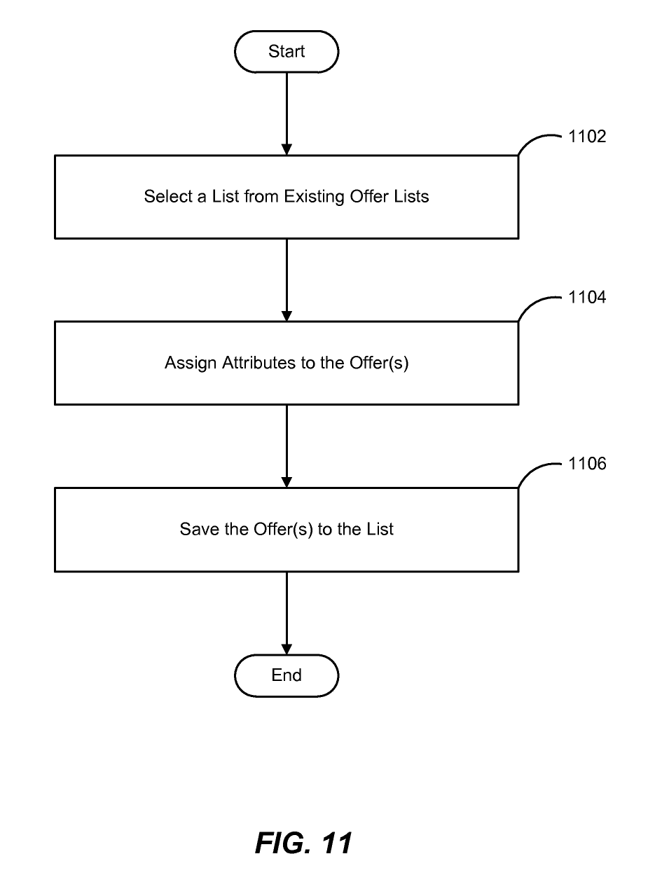

FIG. 11 presents a flowchart generally representing the steps undertaken in one embodiment for saving an offer in an existing personally curated offer list. At step 1102, a personally curated offer list may be selected from a list of existing offer lists. For instance, dropdown menu 1008 in FIG. 10 may be selected to display personalized offer lists, including personally curated offer lists, and a personally curated offer list may be selected such as the list of personally curated offers named “Handbags” discussed above. At step 1104, attributes may be assigned to the offer. For example, a comment about the offer that may be entered in an embodiment into text input box 1014 labeled “Comment Box” in FIG. 10 and input button 1012 labeled “Add a Comment” may be selected to add the comment as an attribute of the offer. At step 1106, the offer may be added to an existing personally curated offer list. Returning to the example of a personally curated offer list that may be selected such as the list of personally curated offers named “Handbags” discussed in conjunction with step 1102, input button 1006 in FIG. 10 may be selected in an embodiment to add the offer to the list named “Handbags”, and input button 1016 labeled “OK” may be selected to perform the operation of adding the offer to the list named “Handbags”.

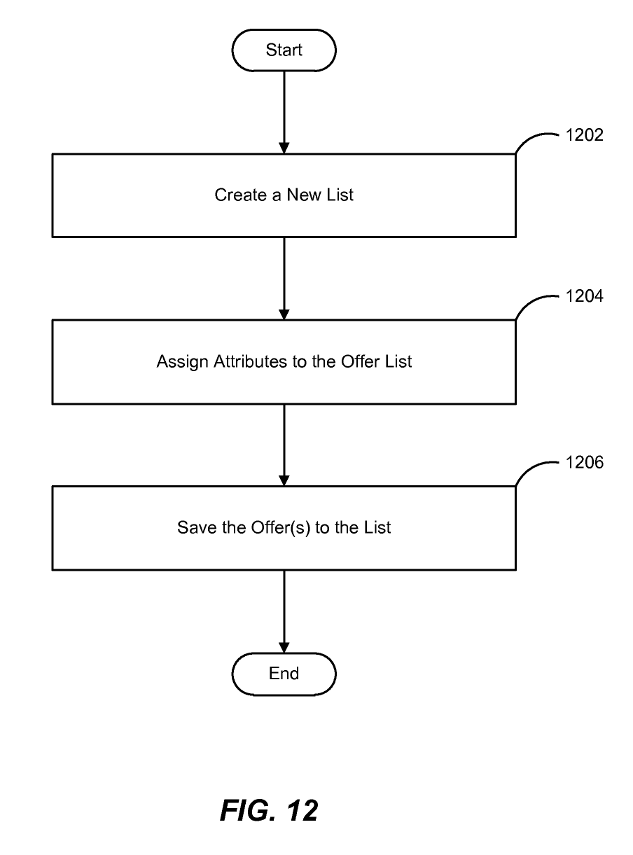

FIG. 12 presents a flowchart generally representing the steps undertaken in one embodiment for saving an offer in a new list of personally curated offers. At step 1202, a new list of personally curated offers may be created. For instance, input button 1010 labeled “Create a New List” in FIG. 10 may be selected to create a personally curated offer list in which the offer may be saved. At step 1204, attributes may be assigned to the offer list. For example, the attributes assigned to an offer list may include a name of the offer list, a text description of the offer list, an image representing the offer list, keywords associated with the offer list, commercial categories associated with the offer list and so forth. At step 1206, the offer may be added to the new list. For example, input button 1006 in FIG. 10 may be selected in an embodiment to add the offer to the new list, and input button 1016 labeled “OK” may be selected to perform the operation of adding the offer to the new list.

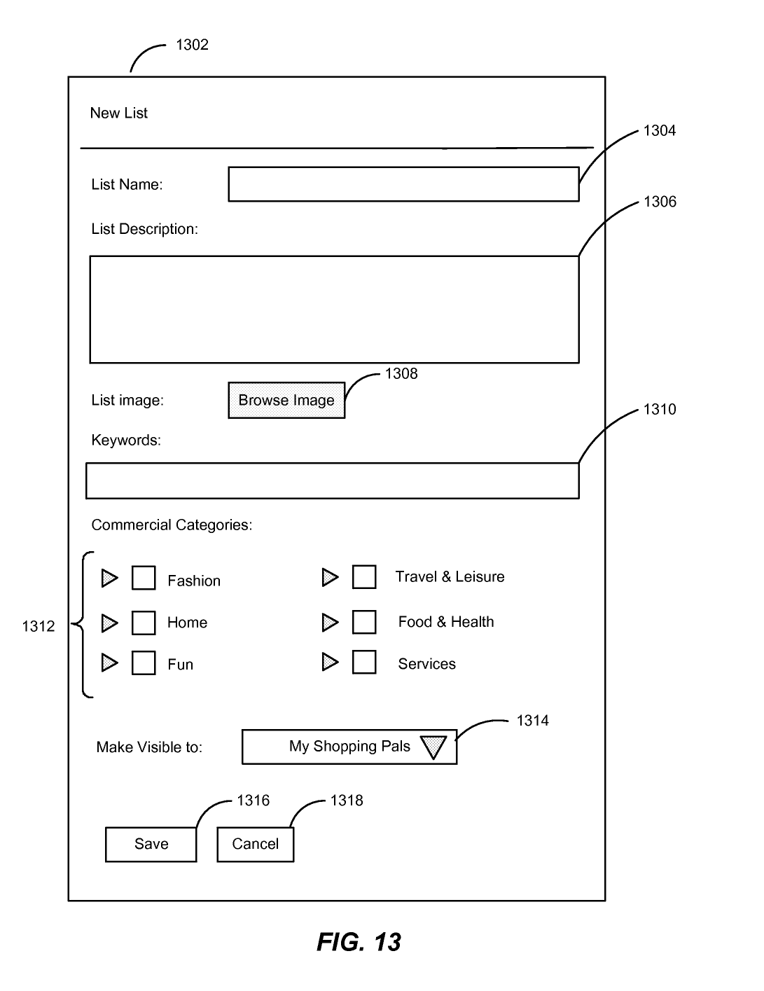

FIG. 13 presents an exemplary illustration generally representing a screen of a graphical user interface for creating a new list in which personally curated offers may be saved. The screen 1302 in FIG. 13 shows the window of a graphical user interface for creating a new list in a web browser executing an offer application. In an embodiment, the window of the graphical user interface for creating a new list may display a text input box 1304 labeled “List Name” for entering the name of the offer list, a text input box 1306 labeled “List Description” for entering a text description of the offer list, an input button 1308 labeled “Browse” to find and select an address of the location of an image representing the offer list, a text input box 1310 labeled “Keywords” for entering keywords associated with the offer list, and input check boxes 1312 for identifying commercial categories associated with the offer list, and so forth.

The window of the graphical user interface for creating a new list may additionally display a dropdown menu 1314 for setting visibility attributes of the offer list for sharing the offer list. An attribute of visibility assigned to the offer list may, for instance, specify for which users of an online service the offer list may be shared including information about the offer list that may be displayed when users of the online service search or browse offer lists. In an embodiment, an attribute of visibility may be assigned a value of a group of users in the online offer service, such as “Shopping Pals” of a user, or may be assigned a value to be open without restriction to users of the online offer service, such as “Everyone”. The window of the graphical user interface for creating a new list may also display an input button 1316 labeled “Save” that may be selected to save the attributes input for association with the offer list, and an input button 1318 labeled “Cancel” that may be selected to cancel the attributes input for association with the offer list.

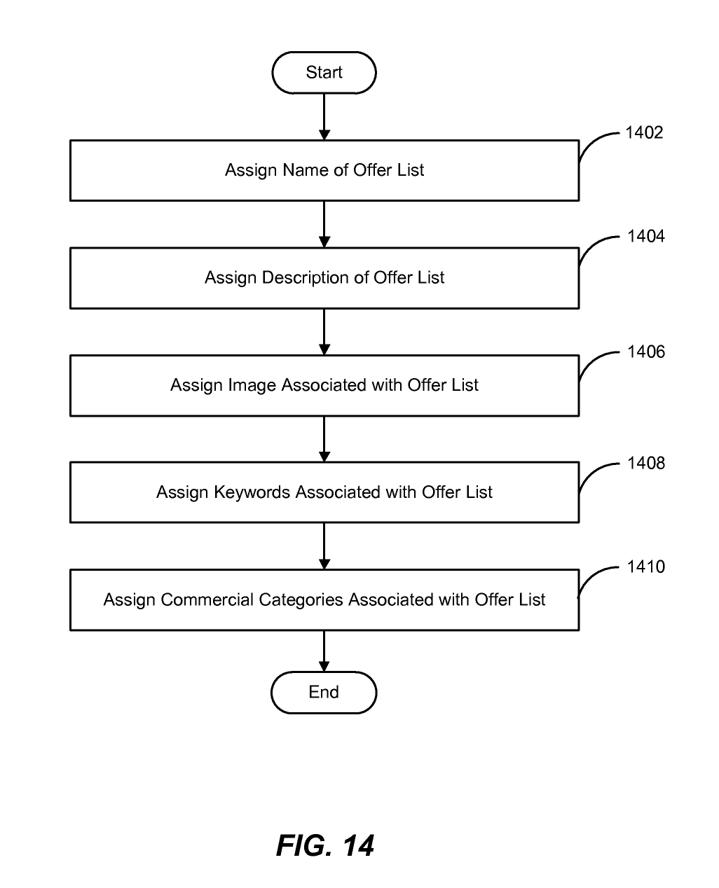

FIG. 14 presents a flowchart generally representing the steps undertaken in one embodiment for assigning attributes to an offer list of personally curated offers. At step 1402, a name of the offer list may be assigned. At step 1404, a description of the offer list may be assigned. For example, the name of an offer list entered into a text input box such as text input box 1304 labeled “List Name” as illustrated in FIG. 13 above may be assigned to the offer list, and a text description of the offer list entered into a text input box such as text input box 1306 labeled “List Description” as illustrated in FIG. 13 above may be assigned to the offer list.

At step 1406, an image associated with the offer list may be assigned. In an embodiment, the image representing the offer list may be selected by entering the address of the location of the image into a text input box or may be selected by the button 1308 labeled “Browse” as illustrated in FIG. 13 above to find and select an address of the location of the image may be assigned to the offer list. At step 1408, one or more keywords associated with the offer list may be assigned. And at step 1410, one or more commercial categories associated with the offer list may be assigned. In an embodiment, keywords associated with the offer list entered into a text input box such as text input box 1310 labeled “Keywords” as illustrated in FIG. 13 above may be assigned to the offer list, and commercial categories associated with the offer list selected by input check boxes 1312 illustrated in FIG. 13 above, or selected by navigating dropdown menus of the commercial categories in an alternate embodiment, may be assigned to the offer list.

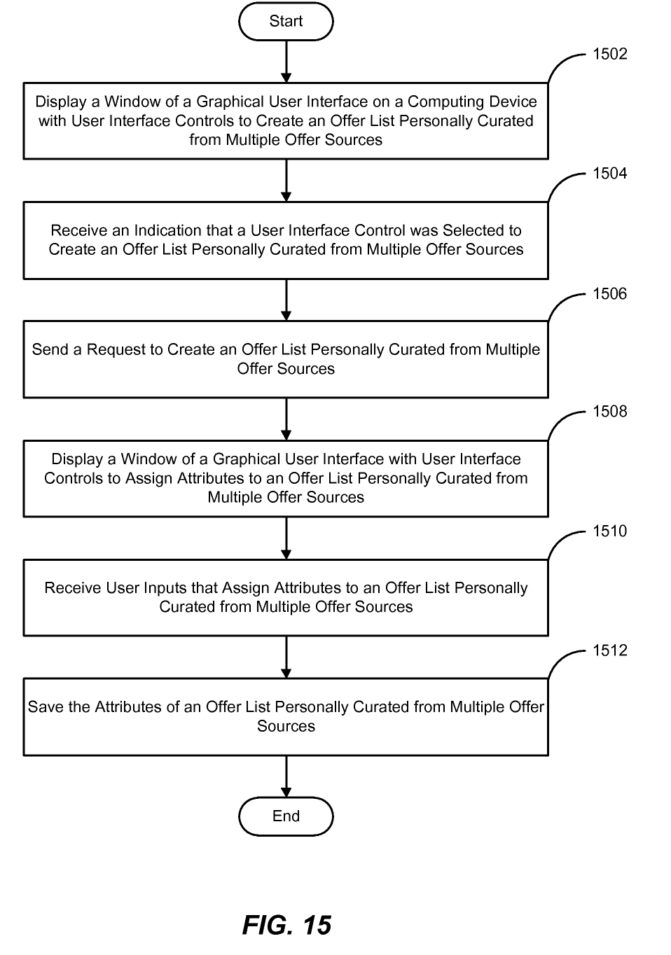

FIG. 15 presents a flowchart generally representing the steps undertaken in one embodiment with a graphical user interface for creating an offer list personally curated from multiple offer sources. At step 1502, a window of a graphical user interface may be displayed on a computing device with user interface controls that may be selected to create an offer list of promotional offers personally curated from multiple offer sources. At step 1504, an indication may be received that a user interface control was selected to create an offer list of promotional offers personally curated from multiple offer sources. For example, a user interface button labeled “New List” 830 as depicted in FIG. 8 or a user interface button labeled “Create a New List” 1010 as depicted in FIG. 10 may be selected by a user input device that generates an indication which may be received that a user interface control was selected to create an offer list of promotional offers personally curated from multiple offer sources.

At step 1506, a request may be sent to create an offer list of promotional offers personally curated from multiple offer sources. In an embodiment, the request may be sent by a client device such as client 202 of FIG. 2 to a server such as server 216 of FIG. 2. At step 1508, a window of a graphical user interface may be displayed with user interface controls to assign attributes for the offer list of promotional offers personally curated from multiple offer sources. In an embodiment, the attributes assigned to an offer list may include a name of the offer list, a text description of the offer list, an image representing the offer list, keywords associated with the offer list, commercial categories associated with the offer list and so forth. At step 1510, user inputs may be received that assign the attributes to the offer list of promotional offers personally curated from multiple offer sources. At step 1512, the attributes may be saved for the offer list of promotional offers personally curated from multiple offer sources. In an embodiment, the attributes may be saved in a database.

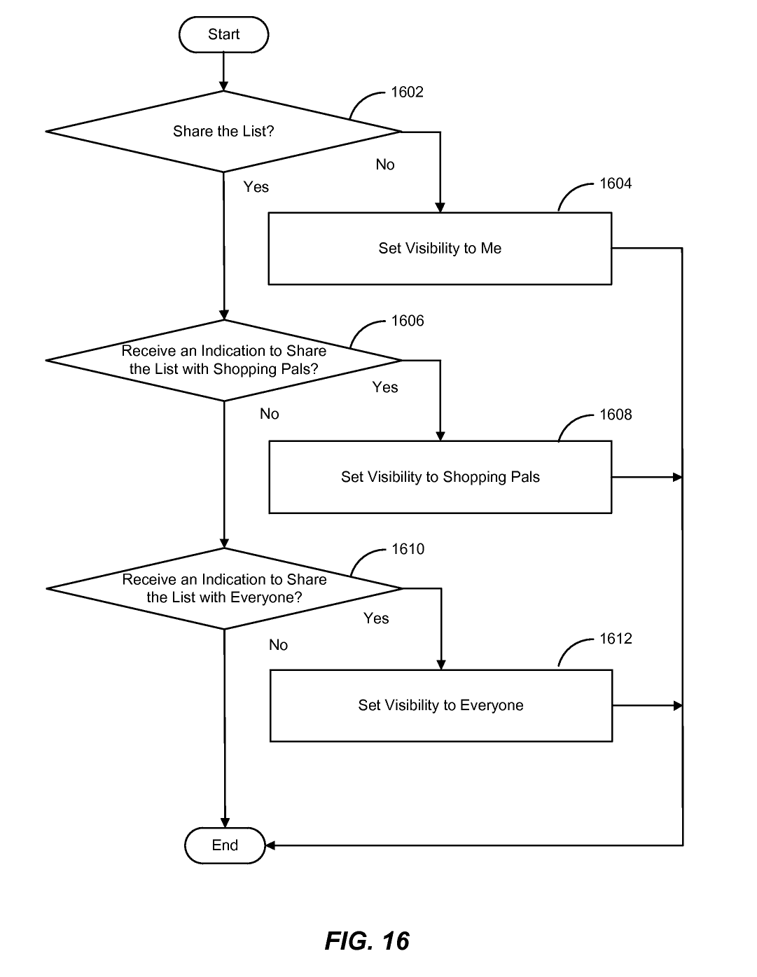

FIG. 16 presents a flowchart generally representing the steps undertaken in one embodiment for sharing a personally curated offer list. At step 1602, it may be determined whether a personally curated offer list is to be shared. In an embodiment, a request may be received to share a personally curated offer list. For instance, an indication may be received from a user input device that a setting was selected in an embodiment to assign a value to an attribute of visibility of the personally curated offer list to share the offer list with users of an online offer service. In various embodiments, a value to an attribute of visibility of the personally curated offer list may be assigned a value of a group of users in an online offer service, such as “Shopping Pals” of the curator of the personally curated offer list, or may be assigned a value to be open without restriction to users of the online offer service, such as “Everyone”.

If it is determined at step 1602 that a personally curated offer list is not to be shared, then the attribute of visibility of the personally curated offer list may be assigned a value at step 1604 that indicates the personally curated offer list is not to be shared. For instance, the attribute of visibility of the personally curated offer list may be assigned a value that restricts visibility to the curator, such as “Me”. If it is determined at step 1602 that a personally curated offer list is to be shared, then it may be determined at step 1606 whether an indication may be received to share the offer list with a group of users of an online offer service, such as shopping pals of the curator. For instance, an indication may be received from a user input device that a setting was selected in an embodiment to assign a value to an attribute of visibility of the personally curated offer list to share the offer list with a group of users of an online offer service, such as shopping pals of the curator. If so, then the attribute of visibility of the personally curated offer list may be assigned a value at step 1608 that indicates the personally curated offer list may be shared with a group of users of an online offer service, such as shopping pals of the curator of the personally curated offer list. Otherwise, it may be determined at step 1610 whether an indication may be received to share the offer list with any users of an online offer service. For instance, an indication may be received from a user input device that a setting was selected in an embodiment to assign a value to an attribute of visibility of the personally curated offer list to share the offer list with any users of an online offer service, such as “Everyone”. If so, then the attribute of visibility of the personally curated offer list may be assigned a value at step 1612 that indicates the personally curated offer list may be shared with any users of an online offer service, such as “Everyone”. Otherwise, processing may be finished for sharing a personally curated offer list.

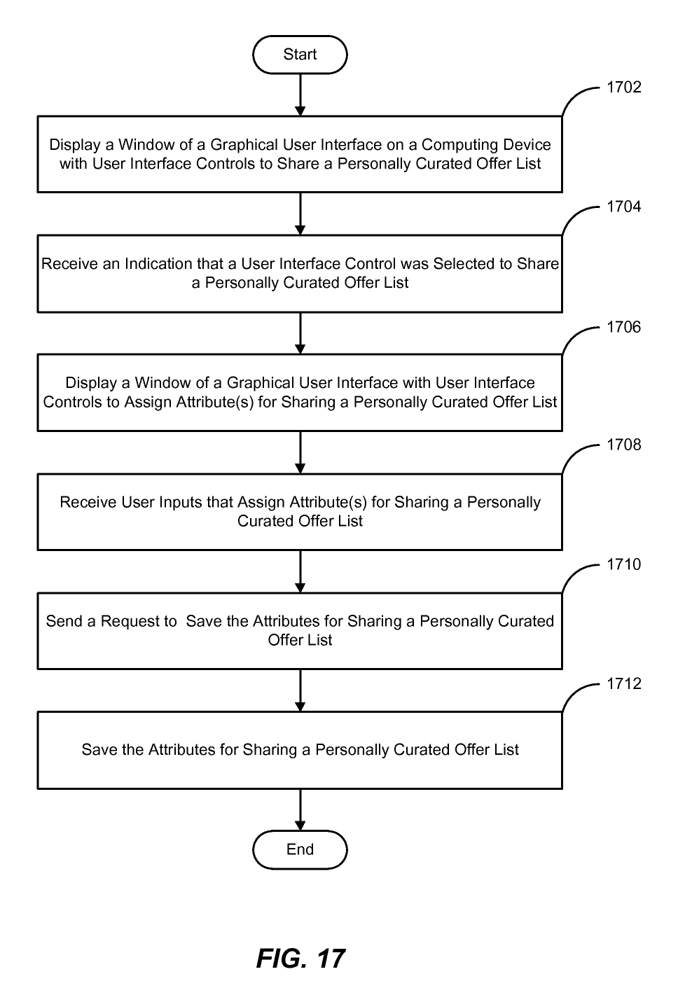

FIG. 17 presents a flowchart generally representing the steps undertaken in one embodiment with a graphical user interface for sharing a personally curated offer list. At step 1702, a window of a graphical user interface may be displayed on a computing device with user interface controls that may be selected to share a personally curated offer list. For example, a user interface control such as dropdown menu 1314 in FIG. 13 may be displayed on a computing device in an embodiment which may be selected to share a personally curated offer list.

At step 1704, an indication may be received that a user interface control was selected to share a personally curated offer list. For instance, a user interface control such as dropdown menu 1314 in FIG. 13 may be selected in an embodiment by a user input device that generates an indication which may be received that a user interface control was selected to share a personally curated offer list. At step 1706, a window of a graphical user interface may be displayed with user interface controls to assign attributes for sharing the personally curated offer list. In an embodiment, the attributes assigned for sharing the personally curated offer list may include an attribute of visibility which may be assigned a value of a group of users in an online offer service, such as “Shopping Pals” of the curator of the personally curated offer list, or may be assigned a value to be open without restriction to any users of the online offer service, such as “Everyone”.

At step 1708, user inputs may be received that assign the attributes for sharing the personally curated offer list. And at step 1710, a request may be sent to save the attributes for sharing a personally curated offer list. In an embodiment, the request may be sent by a client device such as client 202 of FIG. 2 to a server such as server 216 of FIG. 2. At step 1712, the attributes for sharing the personally curated offer list may be saved, for instance in a database.

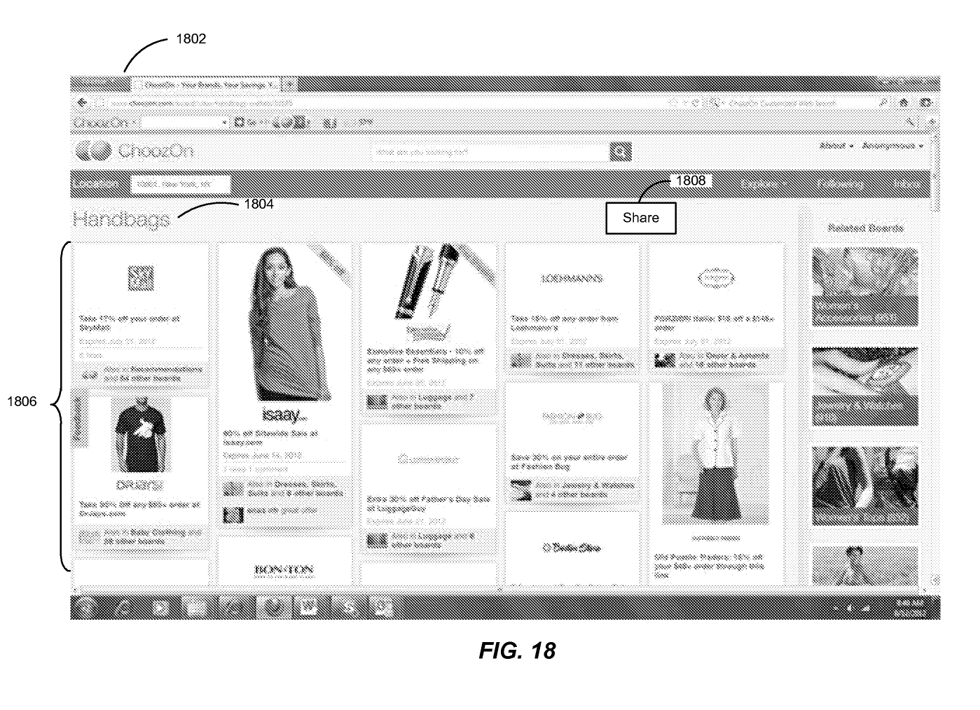

FIG. 18 presents an exemplary illustration generally representing a screen of a graphical user interface in one embodiment for sharing an offer list in an online service. The screen 1802 in FIG. 18 shows the window of a graphical user interface for a web browser executing an offer application which displays a personally curated offer list that the user named “Handbags” 1804. In the embodiment illustrated in FIG. 18, a graphical user interface presents the list of personally curated offers as a board of offers 1806. The window of the graphical user interface for the web browser executing the offer application 1802 may also display user interface elements such as a Share button 1808 which may be selected by the user to share the personally curated offer list with one or more other users.

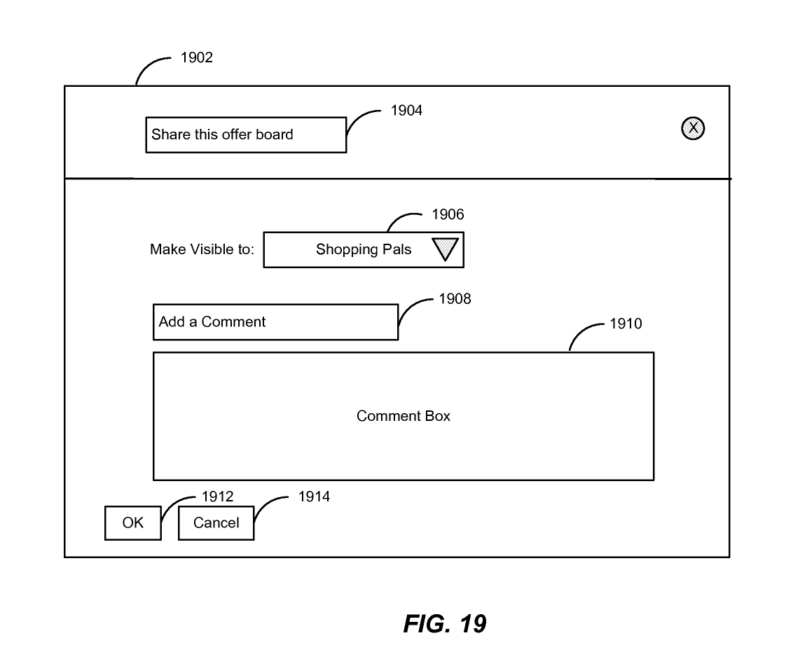

Upon selection of a Share button 1808 in an embodiment, a window of a graphical user interface may be displayed with user interface controls to assign attributes for sharing the personally curated offer list. FIG. 19 is an exemplary illustration generally representing a screen of a graphical user interface for setting attributes in an embodiment to share a personally curated offer list in an online service. The screen 1902 in FIG. 19 shows the window of a graphical user interface for setting attributes to share a board of personally curated offers. In an embodiment, the window of the graphical user interface for setting attributes to share a board of personally curated offers may display user interface elements such as an input button 1904 to share an offer board, a dropdown menu 1906 for setting visibility attributes of the offer board to share the offer board, an input button 1908 labeled “Add a Comment” which may be selected to add a comment about the offer board that may be entered into text input box 1910 labeled “Comment Box”. An attribute of visibility assigned to the offer board may, for instance, specify for which users of an online service the offer board may be shared including information about the offer board that may be displayed when users of the online service search or browse offer boards. In an embodiment, an attribute of visibility may be assigned a value of a group of users in the online offer service, such as “Shopping Pals” of a user, or may be assigned a value to be open without restriction to users of the online offer service, such as “Everyone”.

The window of the graphical user interface for setting attributes to share a board of personally curated offers may also display an input button 1912 labeled “OK” that may be selected to save the attributes input for sharing the offer board, and an input button 1914 labeled “Cancel” that may be selected to cancel the attributes input for sharing the offer board.

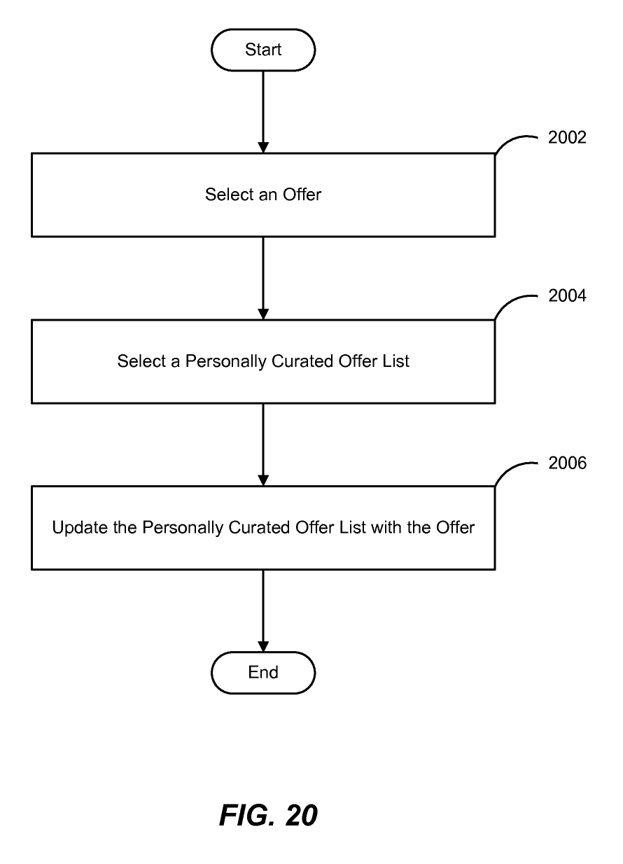

FIG. 20 presents a flowchart generally representing the steps undertaken in one embodiment for updating a personally curated offer list with an offer. At step 2002, an offer may be selected by the curator of an offer list. In various embodiments, the one or more promotional offers may be selected by a curator of an offer list as described above in conjunction with FIGS. 6-7. At step 2004, a personally curated offer list may be selected by the curator of the offer list. And at step 2006, the personally curated offer list may be updated with the offer. In an embodiment, an existing personally curated offer list may be selected by a curator as described above in conjunction with FIG. 11, and the personally curated offer list may be updated with the offer by saving the offer to the personally curated offer list.

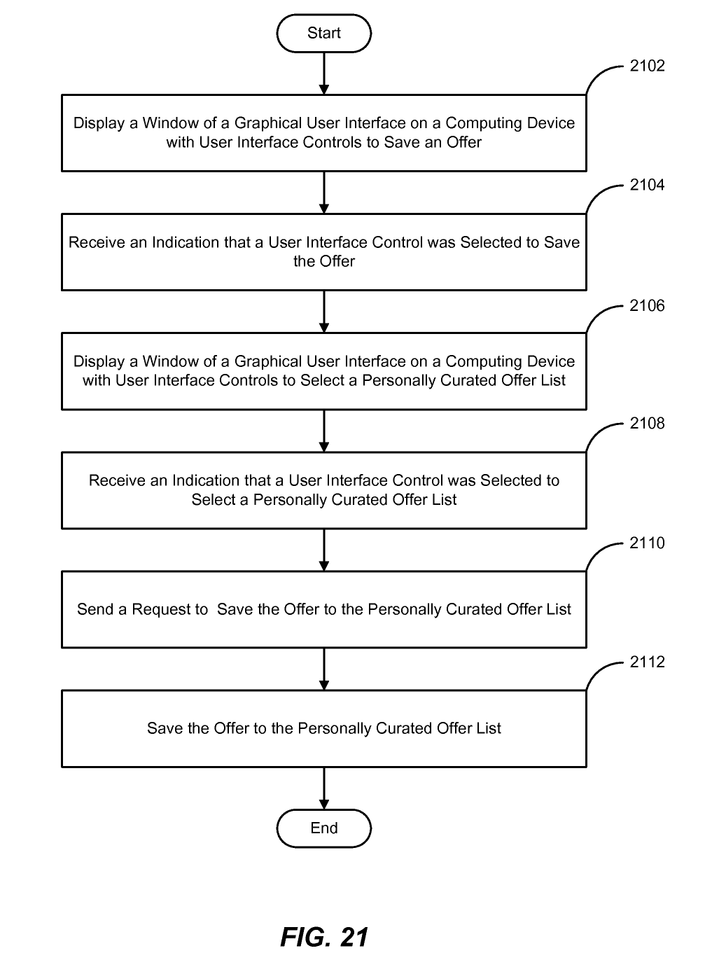

FIG. 21 presents a flowchart generally representing the steps undertaken in one embodiment with a graphical user interface for updating a personally curated offer list with an offer. At step 2102, a window of a graphical user interface may be displayed on a computing device with user interface controls that may be selected to save an offer. For example, a user interface control such as the button 862 labeled “Save” may be displayed on a computing device that may be selected to save an offer to an offer list such as a personally curated offer list. At step 2104, an indication may be received that a user interface control was selected to save an offer. For instance, a user interface control such as the save button 862 in FIG. 8 may be selected in an embodiment by a user input device that generates an indication which may be received that a user interface control was selected to save an offer. At step 2106, a window of a graphical user interface may be displayed with user interface controls to select a personally curated offer list. For instance, an existing personally curated offer list may be selected by a curator in an embodiment as described above in conjunction with FIG. 11.

At step 2108, an indication may be received that a user interface control was selected to select a personally curated offer list. For example, a user interface control such as the dropdown menu 1008 labeled “My Existing Lists” described in conjunction with FIG. 10 may be selected to display personally curated offer lists in an embodiment, and a personally curated offer list displayed among the personally curated offer lists may be selected by a user input device that generates an indication which may be received that a user interface control was selected to select a personally curated offer list. And at step 2110, a request may be sent to save the offer to the personally curated offer list selected. In an embodiment, the request may be sent by a client device such as client 202 of FIG. 2 to a server such as server 216 of FIG. 2. At step 2112, the offer may be saved to the personally curated offer list selected. In various embodiments, a message may be sent from the offer list component 226 to the notification engine 238 of FIG. 2 that a personally curated offer list may be updated with an additional offer.

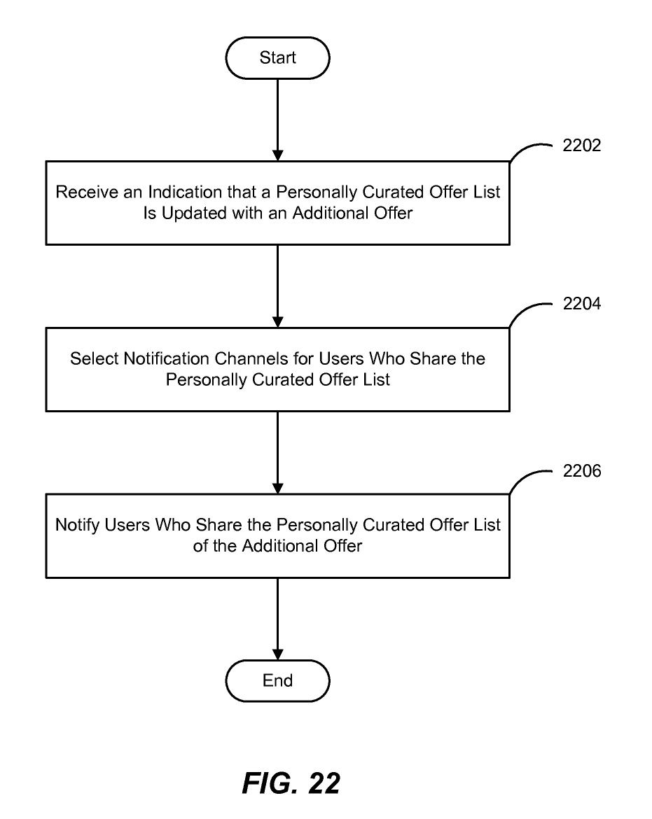

When a personally curated offer list may be updated with an offer, notification of such updates may be sent to users with whom the list is shared. FIG. 22 presents a flowchart generally representing the steps undertaken in one embodiment for notifying others, with whom the personally curated offer list is shared, of updates to the personally curated offer list with additional offers. At step 2202, an indication may be received that a personally curated offer list may be updated with an additional offer. In an embodiment, a personally curated offer list may be updated with an additional offer as described above in conjunction with FIGS. 20-21. At step 2204, notification channels may be selected to notify users with whom the personally curated offer list is shared. For instance, a user may configure the user's profile to receive notification by email, instant messaging, alerts or other instant or periodic notification channels. At step 2206, users may be notified with whom the personally curated offer list is shared. In various embodiments, the updates may be output through multiple notification channels to users with whom the personally curated offer list is shared. This may occur for a particular user, for example, where the user may have configured the user's profile to receive notification by email and an alert on a mobile device.

Thus the present invention may support sharing the personally curated offer list with others, updating the personally curated offer list, and notifying others with whom the list is shared of such updates. Those skilled in the art will appreciate that there may be various implementations of the user interface for personally curating offer lists that may include other navigation controls for creating personally curated offer lists, for managing visibility, and for sharing and browsing of personally curated offer lists. Moreover, there may be various presentations and representations of a personally curated offer list in a graphical user interface such as a stack of offers, a pile of offers, a folder of offers, an album of offers, a bulletin board of offers, a wall of offers and other organizational depictions of a personally curated list of offers. Those skilled in the art will further appreciate that in any presentation and representation of a personally curated offer list in a graphical user interface, an offer list may be depicted by one or more of the attributes assigned to an offer list including a name of the offer list, a text description of the offer list, an image representing the offer list, keywords associated with the offer list, commercial categories associated with the offer list and so forth. Moreover, an offer in a personally curated offer list may similarly be depicted in any presentation and/or representation in a graphical user interface by one or more of the attributes assigned to an offer such as text string of a brand name, an image representing a trade name or product, a headline text of the offer, a description of the offer, an image representing the offer, and so forth. Thus the steps of the present invention may be used for example to post an offer to a personally curated offer list represented in a graphical user interface as a stack of pictures or a collection of pictures on a bulletin board or other online publishing website such as a social network.

As can be seen from the foregoing detailed description, the present invention provides a system and method for personally curating an offer list of promotional offers from multiple offer sources provided by an online service. More particularly, the present invention allows a user to author and manage a personal list of promotional offers curated from multiple offer sources, such as brands, product types, places, deal clubs, shopping pals, offer lists, and so forth. The personally curated offer list may be shared with others such as shopping pals who may have similar interests. New offers may be added to the personally curated offer list, and the present invention may further notify others with whom the list is shared of such updates to the offer list. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for providing offers, comprising:
a consumer offer application that receives a request to perform an operation on a list of a plurality of offers personally curated by a user of an online service;
an offer list component operably coupled to the consumer offer application that performs the operation on the list of the plurality of offers personally curated by the user of the online service; and
a server storage operably coupled to the offer list component that stores the list of the plurality of offers personally curated by the user of the online service and at least one attribute for sharing with other users of an online service the list of the plurality of offers personally curated by the user of the online service.

2. The system of claim 1 further comprising a consumer application programming interface component that the consumer offer application calls to invoke the offer list component to perform the operation on the list of the plurality of offers personally curated by the user of the online service.

3. The system of claim 1 further comprising an offer application operably coupled to the consumer offer application that sends the request to perform the operation on the list of the plurality of offers personally curated by the user of the online service.

4. The system of claim 3 further comprising an offer application user interface operably coupled to the offer application that receives input from the user of the online service interacting through a graphical user interface to request performance of the operation on the list of the plurality of offers personally curated by the user of the online service.

5. The system of claim 4 further comprising a create curated offer list component operably coupled to the offer application user interface that receives input from the user interacting through the graphical user interface to request creating the list of the plurality of offers personally curated by the user of the online service.

6. The system of claim 4 further comprising a curated offer list sharing component operably coupled to the offer application user interface that receives input from the user interacting through the graphical user interface to request sharing with other users of the online service the list of the plurality of offers personally curated by the user of the online service.

7. The system of claim 4 further comprising an edit curated offer list component operably coupled to the offer application user interface that receives input from the user interacting through the graphical user interface to request editing attributes of the list of the plurality of offers personally curated by the user of the online service.

8. The system of claim 4 further comprising a curated offer list updating component operably coupled to the offer application user interface that receives input from the user interacting through the graphical user interface to perform update operations on the list of the plurality of offers personally curated by the user of the online service.

9. The system of claim 4 further comprising an offer view component operably coupled to the offer application user interface that receives input from the user interacting through the graphical user interface to display an offer in the list of the plurality of offers personally curated by the user of the online service.

10. The system of claim 1 further comprising a notification engine operably coupled to the consumer offer application that notifies another user of the online service of the operation performed on the list of the plurality of offers personally curated by the user of the online service.

11. A computer system for providing offers, comprising:
an offer application that sends a request to perform an operation on a list of a plurality of offers personally curated by a user of an online service;
an offer application user interface operably coupled to the offer application that receives input from the user of the online service interacting through a graphical user interface to request performance of the operation on the list of the plurality of offers personally curated by the user of the online service; and
a storage operably coupled to the offer application that stores the list of the plurality of offers personally curated by the user of the online service and at least one attribute for sharing with other users of an online service the list of the plurality of offers personally curated by the user of the online service.

12. The system of claim 11 further comprising a create curated offer list component operably coupled to the offer application user interface that receives input from the user interacting through the graphical user interface to request creating the list of the plurality of offers personally curated by the user of the online service.

13. The system of claim 11 further comprising a curated offer list sharing component operably coupled to the offer application user interface that receives input from the user interacting through the graphical user interface to request sharing with other users of the online service the list of the plurality of offers personally curated by the user of the online service.

14. The system of claim 11 further comprising an edit curated offer list component operably coupled to the offer application user interface that receives input from the user interacting through the graphical user interface to request editing attributes of the list of the plurality of offers personally curated by the user of the online service.

15. The system of claim 11 further comprising a curated offer list updating component operably coupled to the offer application user interface that receives input from the user interacting through the graphical user interface to perform update operations on the list of the plurality of offers personally curated by the user of the online service.

16. The system of claim 13 further comprising an offer view component operably coupled to the offer application user interface that receives input from the user interacting through the graphical user interface to display an offer in the list of the plurality of offers personally curated by the user of the online service.

17. The system of claim 11 further comprising an email application operably coupled to the offer application that receives notification of the operation performed on the list of the plurality of offers personally curated by the user of the online service.

18. A computer system for providing offers, comprising:
means for receiving a request from a user of an online service to obtain a list of a plurality of offers personally curated by another user of the online service and shared by the another user of the online service with the user of the online service;
means for retrieving the list of the plurality of offers personally curated by the another user of the online service and shared by the another user of the online service with the user of the online service; and
means for serving to the user of the online service the list of the plurality of offers personally curated by the another user of the online service and shared by the another user of the online service with the user of the online service to display on a computing device.

19. The computer system of claim 18 further comprising:
means for updating the list of the plurality of offers personally curated by the another user of the online service and shared by the another user of the online service with the user of the online service; and
means for notifying the user of the online service of at least one update to the list of the plurality of offers personally curated by the another user of the online service and shared by the another user of the online service with the user of the online service.

20. A computer system for providing offers, comprising:
means for receiving a request to perform an operation on a list of a plurality of offers personally curated by a user of an online service;
means for performing the operation on the list of the plurality of offers personally curated by the user of the online service; and
means for saving the list of the plurality of offers personally curated by the user of the online service.
